(19) United States
(12) Patent Application Publication
(10) Pub. No.: US 2011/0084053 A1
(43) Pub. Date: Apr. 14, 2011

(54) Narrow Groove Gas Metal Arc Welding Torch

(76) Inventors: Thomas Edward Doyle, Louisville, OH (US); Terry Louis Breaux, Houma, LA (US); Clyde David Noel, Houma, LA (US); Paul Berbakov, Coconut Creek, FL (US)

(21) Appl. No.: 12/577,507

(22) Filed: Oct. 12, 2009

(51) Int. Cl. B23K 9/00

(52) U.S. Cl. 219/136

(57) ABSTRACT

A narrow groove GMAW torch for thick section welding that addresses the problems of conventional welding torches. A main body portion has a power block with electrical, feed welding wire, water cooling, and shielding gas connections and a contact tip. A dielectric is attached to the main body portion and has a primary shield gas outlet. A gas shield attached to the dielectric defines an annulus between them that functions as a secondary gas shield. A diffusing gas outlet in the dielectric delivers shielding gas to the weld area. The contact tip attached to the power block is designed to receive and control the curvature of the feed welding wire.

### FIELD AND BACKGROUND OF INVENTION

The invention is related to welding and more particularly to narrow groove gas metal arc welding.

Commercial narrow groove thick section gas metal arc welding (GMAW) torches use an elongated contact tip with a cylindrical hole for delivery of the wire. There are many variations of contact tips for narrow groove GMAW but all use the same cylindrical hole design. In addition, the contact tip must extend well beyond the gas cup in order to provide the proper contact tip to work distance required for welding. This torch configuration has the following issues.

Inability to control the orientation of the wire cast plane to maintain accurate wire placement in the weld joint. Conventional welding torches use straight cylindrically drilled contact tips. Also, it is very difficult to completely or consistently straighten welding wire. Therefore, with conventional welding tips, the weld wire will exit the end of the contact tip with cast (bend in the wire). The orientation of the cast plane (the direction that the wire leaves the tip) can change given the straight cylindrical tip design. As a result, the location of the wire tip can vary while welding. This is a significant problem in welding deep narrow weld grooves.

If using straightened wire, then inconsistent electrical contact between the contact tip and wire results. The weld wire does require some cast in order to assure electrical contact with the copper tip. Because the wire cast and orientation of the cast plane can vary, the point of electric contact will also change. This undesirable condition is further increased as the contact tip wears. The changing point of electrical contact causes changes in the characteristics of the welding arc. This is an undesirable behavior for welding.

Reduced wear properties, given the poor cooling properties of the elongated contact tip configuration. Current welding torches that use an elongated cylindrical contact tip in order to weld deep narrow grooves have a very thin walled design at the exit of the tip. These welding tips do not do a satisfactory job of cooling the end of the weld tip given the poor thermal conductivity of the thin wall design. As a result, the tips get hotter than desired, thus reducing the wear properties. Poor wear requires frequent changing of the contact tips.

Wasted shielding gas, given the proximity of the gas cup to the end of the contact tip. Current welding torches that use a cylindrical gas cup design forces the location of the gas cup to be on the outside of the standard automated pipe weld grooves. As a result, a significant portion of the welding gas is lost to the sides of the pipe and does not provide shielding for welding. This results in the need to use higher gas flow rates in order to compensate for the partial gas delivery to the point of welding.

In normal weld grooves (non-narrow groove designs) wire placement accuracy is not as critical. However, with narrow groove weld joints the placement of the wire within the weld joint is critical to the resultant weld quality.

### SUMMARY OF INVENTION

The present invention is drawn to a newly designed narrow groove GMAW torch for thick section welding that overcomes the problems of conventional welding torches. A main body portion has a power block with electrical, welding wire, water cooling, and shielding gas connections and a contact tip. A dielectric is attached to the power block. A gas shield attached to the dielectric defines an annulus between them that functions as a secondary gas shield. A diffusing gas outlet in the dielectric delivers shielding gas to the annulus. The contact tip attached to the power block is designed to receive and control the curvature of the feed welding wire.

The various features of novelty which characterize the invention are pointed out with particularity in the claims annexed to and forming part of this disclosure. For a better understanding of the present invention, and the operating advantages attained by its use, reference is made to the accompanying drawings and descriptive matter, forming a part of this disclosure, in which a preferred embodiment of the invention is illustrated.

### BRIEF DESCRIPTION OF THE DRAWINGS

In the accompanying drawings, forming a part of this specification, and in which reference numerals shown in the drawings designate like or corresponding parts throughout the same:

FIG. 1 is a perspective view of the invention.

FIG. 2 is an enlarged view of the welding tip of the invention.

FIG. 3 illustrates the invention in an operational position in a work piece.

### DESCRIPTION OF THE PREFERRED EMBODIMENTS

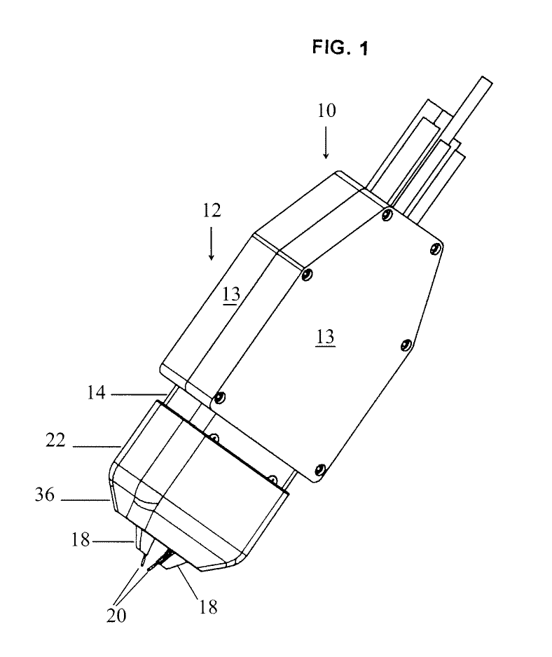

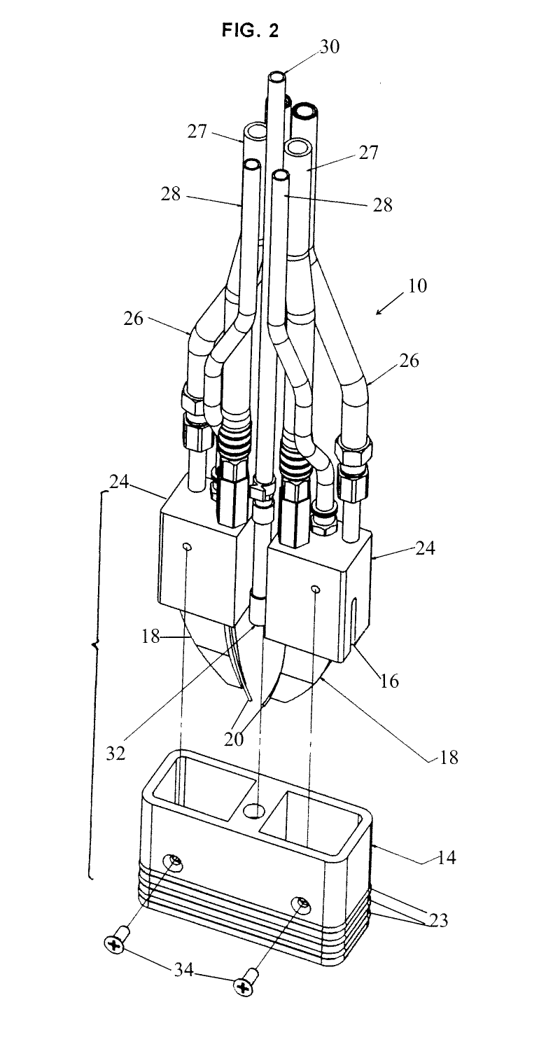

The invention is generally indicated in FIGS. 1 and 2 by numeral 10. The improved narrow groove welding torch 10 is generally comprised of a torch main body 12, molded dielectric 14, primary gas shield 16, contact tips 18, feed welding wire 20, and secondary gas shield 22.

The torch main body 12 is enclosed within two base plates 13 that are fastened together around appropriate connections and structure that forms the main body. As seen in FIG. 2, two water cooled power blocks 24 are positioned adjacent each other. Each power block 24 includes a primary gas shield 16 (also referred to as the lateral gas shield cavity), contact tips 18, and the appropriate connections for power and shielding gas.

Each power block 24 includes a water cooled power cable 26, a feed wire and side shielding gas conduit 27, and return water hose 28. A central shielding gas conduit 30 is positioned between the power blocks 24. The welding torch main body 12 is sized and shaped in accordance with the work to be performed.

The molded dielectric 14 (an insulator cage) is provided with two rectangular passages there through to closely receive the power blocks 24 and a circular passage to receive the central shielding gas conduit 30. The dielectric 14 is attached to the power blocks 24 by screws 34.

The secondary gas shield 22 fits closely over the dielectric 14 and is provided with a stepped down portion 36 having a smaller thickness than the main portion of the secondary gas shield 22. O-rings 23 on the dielectric 14 provide a seal between it and the secondary gas shield 22 to prevent the escape of shielding gas and hold the secondary gas shield 22 in place. Complementary grooves for receiving the O-rings 23 are provided on the dielectric 14 and secondary gas shield 22. The stepped down portion 36 is blade shaped and sized to fit in the gap between the work pieces being welded together. The annulus between the dielectric 14 and secondary gas shield 22 helps to retain the shielding gas during welding operations.

One contact tip 18 is mounted on each power block 24 such that they are separated from but face each other. The contact tips 18 are connected to the electrical wire that is fed through power cables 26 to create the welding arc during operations. The opposing inner edges of the contact tips 18 are sized to receive and hold the feed wire 20 and curved to force the feed wire 20 to be in consistent contact with the contact tips 18. In order to maintain the consistent contact of the feed wire 20 with the contact tips 18 it is preferable that the radius of the curvature on the contact tips 18 be smaller than the natural radius of the feed wire 20. While the drawings illustrate the presence of two contact tips and feed wires it should be understood that this is for illustration purposes only and one contact tip and feed wire may be used in the appropriate welding situation.

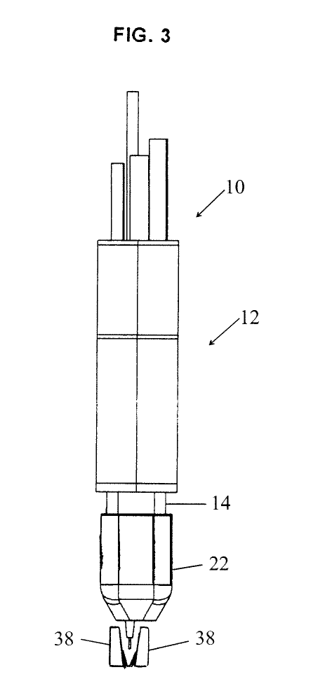

In operation, as seen in FIG. 3, the contact tips 18 are inserted between the work pieces 38 to be welded together and the welding operation is started. The dispensing of shielding gas through the primary gas shield 16 and shielding gas diffuser 32 in the annulus between the secondary gas shield 22 and dielectric 14, the addition of feed wire 20, electrical control of the welding arc, and movement of the welding torch 10 are accomplished in the normal manner to achieve the desired weld joint between the work pieces 38. Two different shielding gases may be used if desired.

The invention provides several advantages over the prior art torches.

The invention allows improved wire position control while welding.

The invention provides improved consistency of electrical contact between the wire and the contact tip.

The invention provides improved wear life of the contact tip. The size and shape of the contact tips 18 allows the use of an increased amount of copper in the contact tips, relative to previously used contact tips. The increased copper promotes heat conduction, which results in keeping the contact tips cooler and improved wear characteristics.

The invention provides better gas shielding at the weld pool.

An advantage of the secondary gas shield 22 is that it allows the use of two different shielding gases. Because shielding gases are critical to consistent, quality welds they can be expensive. The inventive design allows the use of the more critical, expensive shielding gas through primary gas shield 16 and the use of a second less expensive gas to be directed into the annulus between the dielectric 14 and the secondary gas shield 22.

While specific embodiments and/or details of the invention have been shown and described above to illustrate the application of the principles of the invention, it is understood that this invention may be embodied as more fully described in the claims, or as otherwise known by those skilled in the art (including any and all equivalents), without departing from such principles.

What is claimed as invention is:

1. A narrow groove gas metal arc welding torch, comprising:
a. a power block having electrical, feed welding wire, water cooling, and shielding gas connections;
b. a dielectric attached to the power block;
c. a gas shield attached to the dielectric that defines an annulus between the shield and dielectric;
d. a contact tip attached to the power block that receives and controls the curvature of a feed welding wire; and
e. a shielding gas diffuser provided on the dielectric.

2. The narrow groove gas metal arc welding torch of claim 1, wherein the portion of the contact tip in contact with the welding feed wire has a radius of curvature smaller than the natural radius of the feed welding wire.

3. The narrow groove gas metal arc welding torch of claim 1, further comprising a shielding gas outlet port provided in the dielectric such that shielding gas is delivered in the annulus defined between the molded dielectric and the gas shield.

4. The narrow groove gas metal arc welding torch of claim 1, wherein the contact tip is formed of copper.

5. A narrow groove gas metal arc welding torch, comprising:
a. a power block having electrical, welding wire, water cooling, and shielding gas connections;
b. a dielectric attached to the main body portion, said dielectric having an outlet for shielding gas;
c. a gas shield attached to the dielectric that defines an annulus between the gas shield and dielectric;
d. a diffusing gas outlet provided on the dielectric to deliver shielding gas in the annulus defined between the dielectric and gas shield attached to the dielectric.
e. a contact tip attached to the power block that receives and controls the curvature of a welding feed wire, with the portion of the contact tip in contact with the welding having a radius of curvature smaller than the natural radius of the feed wire; and
f. a diffusing gas outlet provided on the dielectric.
